(19) United States
(12) Patent Application Publication
(10) Pub. No.: US 2025/0303745 A1
(43) Pub. Date: Oct. 2, 2025

(54) PRINTING APPARATUS AND METHOD OF CONTROLLING THE SAME

(71) Applicant: Genix Corporation, Seongnam-si (KR)

(72) Inventors: Steve Park, Seongnam-si (KR); Il Kwon Kang, Yongin-si (KR)

(21) Appl. No.: 19/021,727

(22) Filed: Jan. 15, 2025

(30) Foreign Application Priority Data
Mar. 29, 2024 (KR) 10-2024-0043620

(51) Int. Cl. B41J 2/325; B41J 3/54; B41J 11/00

(52) U.S. Cl. CPC B41J 2/325; B41J 3/54; B41J 11/0095

(57) ABSTRACT

A printing apparatus is proposed. The apparatus may include a housing, a first printing unit configured to move in a direction with reference to the housing and print a color image having cyan, yellow, magenta, and black (CYMK) colors onto a first print area of a print medium through a digital method. The apparatus may also include a second printing unit located on a movement path of the print medium and configured to apply white ink onto a second print area, The apparatus may further include a processor configured to control an operation of at least one of the first printing unit and the second printing unit, and the second print area may include at least a portion of the first print area.

### CROSS-REFERENCE TO RELATED APPLICATION

This application is based on and claims priority under 35 U.S.C. § 119 to Korean Patent Application No. 10-2024-0043620, filed on Mar. 29, 2024, in the Korean Intellectual Property Office, the disclosure of which is incorporated by reference herein in its entirety.

### BACKGROUND

### Technical Field

The disclosure relates to a hybrid-type printing apparatus, in which a digital transfer method is used, and a method of controlling the printing apparatus, and more particularly, to a printing apparatus configured to apply white ink onto a print area onto which a color image is printed, by using a thermal transfer method, and a method of controlling the printing apparatus.

### Description of Related Technology

Color images such as artworks, texts, and logos may be printed onto print media such as paper or transfer films.

### SUMMARY

One aspect is a printing apparatus that includes a housing, a first printing unit configured to move in a direction with reference to the housing and print a color image having cyan, yellow, magenta, and black (CYMK) colors, through a digital method, onto a first print area of a print medium, a second printing unit located on a movement path of the print medium and configured to apply white ink onto a second print area, a processor configured to control an operation of at least one of the first printing unit and the second printing unit, wherein the second printing area includes at least an area of the first printing area.

After the color image has been printed onto the first printing area by the first printing unit, the white ink may be applied onto the second print area by the second printing unit.

The second printing unit is apart from the first printing unit in a direction in which the print medium moves.

The second printing unit may include an ink ribbon including the white ink, a first roll around which an end of the ink ribbon is wound, a second roll around which the other end of the ink ribbon is wound, and a thermal transfer head configured to thermally transfer the white ink from the ink ribbon onto the second print area, and after the white ink has been thermally transferred from the ink ribbon, which is unwound from the first roll, to the second print area, the ink ribbon, from which the white ink has been peeled off, is wound around the second roll.

The ink ribbon may further include a first surface including the white ink and being in contact with at least an area of the print medium by the thermal transfer head during thermal transfer, and a second surface that does not include the white ink and is in contact with the thermal transfer head during thermal transfer.

The printing apparatus may further include a sensor located on a movement path of the print medium and configured to generate a trigger signal in response to a marker printed onto the print medium, and the processor is configured to initiate an operation of the second printing unit based on the generated trigger signal.

The marker may include at least one of a Quick Response (QR) code, a register mark, and an encoder marking.

Another aspect is a method of controlling a printing apparatus that includes moving of a print medium in a direction, with reference to a housing, printing a color image having cyan, yellow, magenta, and black (CYMK) colors, through a digital method, on a first print area of the print medium by a first printing unit located on a movement path of the print medium, and applying of white ink onto a second printing area by a second printing unit located on the movement path of the print medium, wherein the second printing area includes at least an area of the first printing area.

The second printing unit includes an ink ribbon including the white ink, a first roll around which an end of the ink ribbon is wound, a second roll around which the other end of the ink ribbon is wound, and a thermal transfer head configured to thermally transfer the white ink from the ink ribbon onto the second print area, and the printing of the white ink onto the second print area by the second printing unit includes initiating an operation of the second printing unit, controlling the ink ribbon to be unwound from the first roll and then wound around the second roll, and thermally transferring the white ink, by the thermal transfer head, from the ink ribbon onto the second print area.

The initiating of the operation of the second printing unit includes generating a trigger signal, by a sensor, in response to the marker printed onto the print medium, and initiating the operation of the second printing unit based on the trigger signal that has been generated.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a perspective view of a printing apparatus 100 according to an embodiment.

FIG. 2 is a cross-sectional view for describing an internal configuration of the printing apparatus 100 shown in FIG. 1.

FIG. 3 is a cross-sectional view for describing a second printing unit shown in FIG. 1 in detail.

FIG. 4 is a cross-sectional view of a printing apparatus according to another embodiment.

FIG. 5 is a diagram illustrating a state in which a color image has not been printed onto a print area.

FIG. 6 is a diagram illustrating a state in which a color image has been printed onto the print area shown in FIG. 5.

FIG. 7 is a diagram illustrating a state in which white ink is being applied onto the print area shown in FIG. 6.

FIG. 8 is a diagram illustrating a state in which white ink has been applied onto a print medium shown in FIG. 7.

FIG. 9 is a flowchart for describing e a method of controlling a printing apparatus, according to an embodiment.

### DETAILED DESCRIPTION

Color images printed onto print media by using a thermal transfer method may be printed onto other print media such as paper, industrial products processed by using plastic and like, fabrics, or clothes.

In this case, compared with a case where a new print medium has a light color, when the new print medium has a clear or dark color, a chroma of an image attached onto the new print medium may significantly decrease.

Accordingly, there is increasing interest in a printing method of expressing vivid color images to be originally implemented without regard to colors of new print media onto which color images are printed.

In the disclosure, before a color image printed onto a print area of a print medium is thermally transferred onto a new print medium, a white blocking layer is formed by applying white ink onto the entire portion of the print area so that the clarity of the color image printed onto the new print medium is improved.

To form the white blocking layer, when the white ink is sprayed together in a process of printing the color image onto the print medium by using a laser print, the white ink may be sprayed without uniformity onto the print area, and particles of the sprayed white ink may be mixed with other inks having cyan, yellow, magenta, and black (CYMK) colors being previous to or simultaneously with the white ink. Accordingly, the white blocking layer may not be uniformly formed in each print area, and the white blocking layer having a sufficient thickness may not be formed.

In addition, when the white ink is sprayed by using the inkjet printer, as particles sprayed to form the white blocking layer have a greater size, the blocking ability may be improved, but a nozzle configured to spray the white ink may be frequently choked up.

In the disclosure, by applying the white ink onto the print area of the print medium by using the thermal transfer method, breakage of the printing apparatus may be prevented beforehand, and by forming the white blocking layer having a uniform and sufficient thickness in the print area of the print medium, the clarity of the color image printed onto the new print medium may be improved.

Furthermore, in the disclosure, by printing the color image onto the print area of the print medium and forming the white blocking layer, by using one printing apparatus and through one process, the production efficiency of the printing apparatus may also be improved.

Technical goals to be achieved through embodiments are not limited thereto, and other technical goals not mentioned herein may be clearly understood to one of ordinary skill in the art based on the present specification and the accompanying drawings.

Additional aspects will be set forth in part in the description which follows and, in part, will be apparent from the description, or may be learned by practice of the presented embodiments of the disclosure.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Regarding terms used in embodiments, general terms currently and wisely used are selected in consideration of functions in the disclosure. However, meanings of the terms may be changed according to intentions of one of ordinary skill in the art, judicial precedence, appearance of a new technology, and the like. In addition, in certain cases, terms may be arbitrarily selected by the applicant in particular cases. In such a case, the meaning of the terms will be described in detail at the corresponding portion in the description of the disclosure. Therefore, the terms used in the disclosure should be defined based on the meanings of the terms and the descriptions throughout the disclosure.

The terms used in the embodiments are only used to describe particular embodiments, and are not used to limit the embodiments. In embodiments, unless explicitly indicates a singular expression, the singular expression may also encompass a plural expression.

In the disclosure, expression that a portion “includes” components or operations should not be interpreted as including all components or operations, but should be interpreted that the portion may not include some of the components or operations or further include additional components and operations.

In addition, in the disclosure, orders of operations describing the method according to embodiments are not limited orders of the operations described herein, and may be performed in appropriate orders considering the functions in the disclosure.

As used herein, an expression such as “at least only one” precedes arranged elements, it modifies all elements rather than each arranged elements. For example, the expression “at least any one of a, b, and c” should be construed to include a, b, c, or a and b, a and c, b and c, or a, b, and c.

In addition, when a component is “connected” to another component, this not only includes “being directly connected”, but also includes “being electrically connected” with another component therebetween.

The terms “-er”, “-or”, and “module” described in the disclosure indicate units for processing at least one function and operation, and may be implemented by hardware components or software components and combinations thereof.

Sizes or ratios of some components in the drawings may be rather exaggerated. In addition, components illustrated in some of the drawings may not be illustrated in others.

Hereinafter, the embodiments will be described in detail with reference to the accompanying drawings such that the embodiments may be easily practiced by one of ordinary skill in the art. However, the embodiments may be implemented in many different forms, and are not limited to the embodiments described herein.

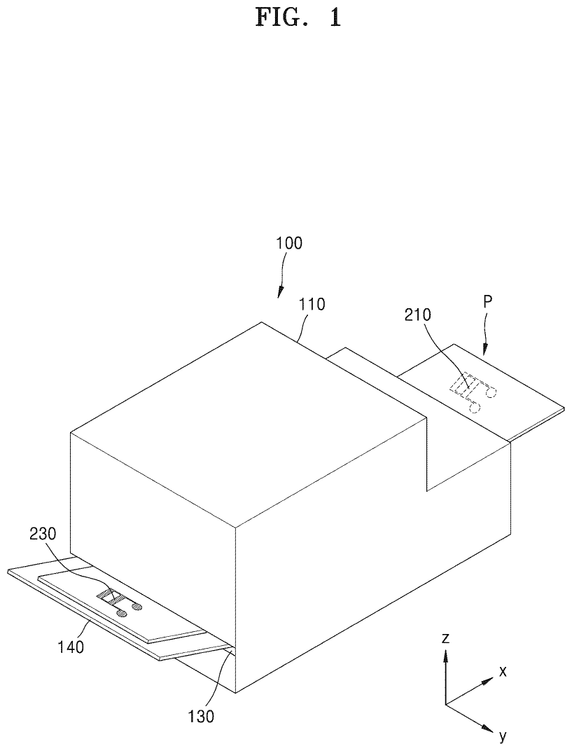

FIG. 1 is a perspective view of a printing apparatus 100 according to an embodiment. Referring to FIG. 1, the printing apparatus 100 according to an embodiment may include a housing 110, an inlet (not shown), an outlet 130, and a stacker 140.

The housing 110 may form the entire appearance of the printing apparatus 100, and components of the printing apparatus 100 may be accommodated in an internal space (or ‘a mounting space’) of the housing 110.

The inlet for inserting or inputting a print medium P into the internal space of the housing 110 may be formed in an area of the housing 110. The print medium P may be inserted into the internal space of the housing 110 through the inlet.

One or more driving units configured to move a print medium P in a direction (e.g., a −x axis direction) with reference to the housing 110 may be further arranged in the internal space of the housing 110. For example, driving units may include a rail, a rack-and-pinion actuator, a driving roller, a gear, and a belt, and thus may move the print medium P in a direction.

The outlet 130 may be formed in another area of the housing 110 that is apart from the area of the housing 110 in which the inlet is formed. The area of the housing 110, in which the inlet is formed, and the other area of the housing 110, in which the outlet 130 is formed, may be arranged to face each other with reference to the housing 110.

The print medium P inserted into the internal space of the housing 110 through the inlet of the housing 110 may be moved in a direction (e.g., the −x axis direction) by a driving unit accommodated in the internal space of the housing 110, and then may be output or discharged to outside of the housing 110 through the outlet 130.

The print media P output to the outside of the housing 110 through the outlet 130 may be stacked on the stacker 140. The stacker 140 may be in an area adjacent to the outlet 130, and thus may support the print media P output from the outlet 130. The print media P output from the outlet 130 may be stacked up on the stacker 140.

A first print area, onto which a color image is printed, may be arranged in at least an area of the print medium P. Here, the print medium P may include paper or a transfer film. However, the type of the print medium P is not limited thereto, and the print medium P may also include fabrics or clothes.

A color image may be printed onto the first print area. For example, an image having a certain color such as cyan, yellow, magenta, and black (CYMK) may be printed on the print area. Color images having CYMK colors may be printed onto the print area by a printing apparatus in which a digital method is used.

The image printed onto the first print area may include artworks, texts, logos, or the like, and the print medium P in which the print area is arranged may include paper or a transfer film. An adhesive may be further applied onto a surface of the first print area, onto which the image has been printed, and the image of the first print area onto which the adhesive has been further applied may be attached or transferred, through thermal transfer, onto new print media such as paper, industrial products processed by using plastic, fabrics, clothes, and the like.

When the new print medium is clear or has dark colors, images transferred onto the new print media may be unclearly expressed. Compared with a case where the new print medium has a light color, when the new print medium is clear or has dark colors, a chroma of the image transferred onto the new print media may significantly decrease.

A second print area for applying the white ink may be arranged in at least an area of the print medium P. The second print area may be arranged at a same position as the first print area on the print medium P, and thus may include at least a portion of the first print area.

In the disclosure, ink may indicate a liquid or solid material including a coloring or a pigment used for printing images. For example, ink may include a material included in an ink cartridge of an inkjet printer or a toner of a laser printer and used for expressing images having certain colors onto print media output from the printers.

Ink may be sprayed in the form of particles. For example, ink may include dried powder or dried powder in a charged state. However, ink is not limited thereto and may also be applied in the form of a film constructing a layer having a certain thickness.

The second print area may include the entire area of the first print area. An area of the print medium P, which is occupied by the second print area, may be equal to or greater than an area of the print medium P occupied by the first print area.

As the white ink is applied to the second print area, the white ink may be applied onto the entire surface of the first print area onto which the image has been printed. Due to the white ink applied onto the second print area, an image having white color may be expressed together with the image printed onto the first print area. In addition, due to the white ink applied onto the second print area, the white blocking layer may be formed on a surface of the image printed onto the first print area.

Due to the white blocking layer, which is formed as the white ink is applied onto the second print area, the clarity of an image printed onto a new print medium may be improved. As the white ink applied onto the second print area forms the white blocking area, the clarity of the image printed onto the new print medium may be improved. The white blocking layer may improve the clarity of the image attached onto the new print medium by blocking light reflected from the new print medium to the image.

To apply the white ink onto the print area, a printing unit including an additional nozzle configured to spray the white ink in the form of particles may be used. Here, as the white ink being sprayed has a greater particle size, blocking ability of the white blocking layer formed by the white ink may be improved. However, when the particle size of the white ink is excessively great, the nozzle configured to spray the white ink may be frequently choked up.

In addition, when the white blocking layer is formed by spraying the white ink having the form of particles, there is possibility that the white blocking layer is formed without uniformity. The white ink may be formed onto the print area without uniformity, and scattered particles of the white ink may be mixed with ink having CYMK colors being sprayed previous to or simultaneously with the white ink. Accordingly, the white blocking layer may be not uniformly formed in each print area, and the white blocking layer having a sufficiently great thickness may not be formed.

The printing apparatus 100 according to an embodiment may apply the white ink onto the print area of the print medium P by using the thermal transfer method such that the white ink having the form of a film forms the white blocking layer in the print area of the print medium P. In this case, the white blocking layer being formed may have a uniform and sufficient thickness, and thus, the clarity of the color image printed again onto the new print medium may be improved.

In addition, the printing apparatus 100 according to an embodiment may print color images onto the print area of the print medium P and form the white blocking layer, by using one printing apparatus 100 and through one process, and therefore, the production efficiency of the printing apparatus 100 may be improved.

More particularly, when the color image is printed by spraying the ink having the form of particles, an empty space may be formed between particles for expressing the color image. The printing apparatus 100 according to an embodiment may additionally apply the white blocking layer onto a surface of the printed color image, and by doing so, may completely block the empty space in the color image from the outside.

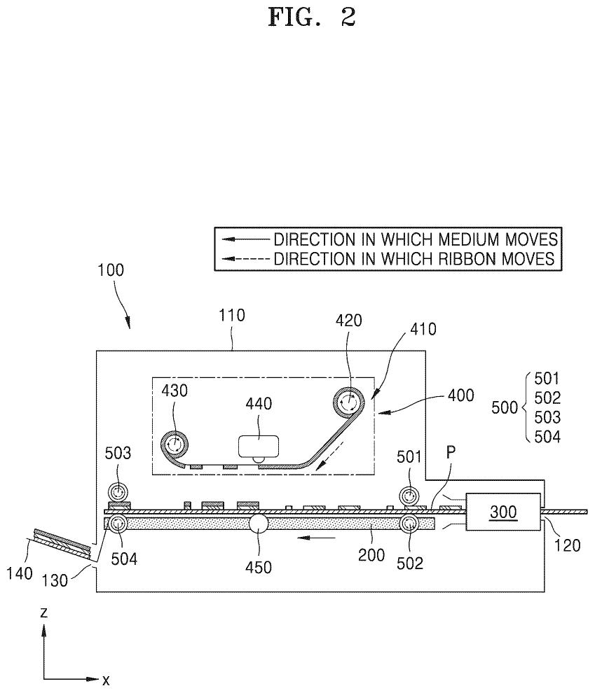

Hereinafter, the printing apparatus 100 configured to apply the white ink onto the print medium P onto which a color image is printed, by using the thermal transfer method, will be described with reference to FIGS. 2 to 4.

FIG. 2 is a cross-sectional view for describing an internal configuration of the printing apparatus 100 shown in FIG. 1. Referring to FIG. 2, the printing apparatus 100 may include the housing 110, an inlet 120, the outlet 130, the stacker 140, a first printing unit 300, a second printing unit 400, and a driving unit 500. The printing apparatus 100 shown in FIG. 2 may be an embodiment of the printing apparatus 100 shown in FIG. 1, and descriptions thereof will not be repeatedly given. Components related to the embodiments are shown in the printing apparatus 100 shown in FIG. 2, and it would be obvious to one of ordinary skill in the art that other components may be further included in the printing apparatus 100 in addition to the components shown in FIG. 2.

The inlet 120 may be formed in an area of the housing 110. The outlet 130 may be formed in another area of the housing 110, and the area and the other area may be arranged to face each other with reference to the housing 110. The print medium P may be inserted into the housing 110 through the inlet 120, output to the outside of the housing 110 through the outlet 130, and stacked on the stacker 140.

One or more driving units 500 configured to move the print medium P in a direction (e.g., the −x axis direction) may be accommodated in the internal space of the housing 110. For example, the one or more driving units 500 may include a rail, a rack-and-pinion actuator, a driving roller, a gear, and a belt, and thus may move the print medium P in a direction.

The driving unit 500 may be arranged at an upper end and/or a lower end of the print medium P located upstream and/or downstream the print medium P to move the print medium P in a certain direction.

In the disclosure, the wording “upstream the printing apparatus” may indicate an area of a movement path of the print medium P located before the print medium P arrives at the second printing unit 400. For example, the upstream of the printing apparatus 100 may indicate an area located between the inlet 120 of the printing apparatus 100 and the second printing unit 400.

In addition, in the disclosure, the wording “downstream the printing apparatus 100” may indicate an area of the movement path of the print medium P located after the print medium P passes through the second printing unit 400. For example, the downstream of the printing apparatus 100 may indicate an area located between the second printing unit 400 and the outlet 130 of the printing apparatus 100.

For example, a first driving unit 501 and a second driving unit 502 may be at the upper end and the lower end upstream the printing apparatus 100, respectively, and a third driving unit 503 and a fourth driving unit 504 may be at the upper end and the lower end of the print medium P downstream the printing apparatus 100, respectively.

In addition, in an area of the movement path of the print medium P, at which the print medium P arrives at the second printing unit 400, a flat-roll 450 may be arranged at the lower end of the print medium P as a driving unit of the print medium P. The flat-roll 450 may support the print medium P while thermal transfer is performed by a thermal transfer head 440. In addition, the flat-roll 450 may facilitate moving and pause of the print medium P even while thermal transfer is performed on the print area of the print medium P by the thermal transfer head 440.

The driving unit 500 may further include a flat-bed 200 for supporting and guiding the print medium P. Holes penetrating the flat-bed 200 may be formed in an area of the flat-bed 200, and the second driving unit 502, the fourth driving unit 504, and the flat-roll 450, which are arranged at the lower end of the print medium P, may be accommodated in the holes that have been formed.

Although an embodiment in which only the print medium P is moved in a direction by the driving unit 500 and the flat-bed 200 does not move is illustrated in the drawing, the embodiment is not limited thereto. As another example, the driving unit 500 may be arranged at the upper end and/or the lower end of the flat-bed 200 located upstream and/or downstream the printing apparatus 100 to move the flat-bed 200 and the print medium P in a direction.

The first printing unit 300 may be on the movement path of the print medium P, and may print color images having CYMK colors onto the print area of the print medium P. The first printing unit 300 may print color images having CYMK colors onto the print area of the print medium P by using a digital method. For example, the first printing unit 300 may include a printing unit configured to print color images having CYMK colors by using laser beams or light-emitting diodes (LED). To express images having CYMK colors on the print area, the first printing unit 300 may spray charged ink having the form of dry particles onto the print area, by using the laser.

The second printing unit 400 may be on the movement path of the print medium P, and may further apply white ink, by using the thermal transfer method, onto the print area where the color image having CYMK colors has been printed. As the white ink having the form of a film is applied onto the print area of the print medium P, the white blocking layer may be formed on the surface of the color image.

The white blocking layer, which is formed by applying white ink having the form of a film by using the thermal transfer method, may have a uniform and sufficient thickness. More particularly, even when ink having CYMK colors sprayed onto the print area to express the color image has the form of particles, even an empty space due to a particle size of the ink having CYMK colors may be blocked against the outside due to the white blocking layer.

In this case, the print area onto which the white ink is applied may include at least a portion of the print area, onto which the color image having CYMK colors is printed. In the print medium P, an area occupied by an area onto which the white ink is applied may be equal to or greater than an area onto which the color image is printed.

As the white ink is applied onto a surface of the color image, an image having white color may be expressed together with the color image having CYMK colors on the print area. In this case, too, the white blocking layer may be formed on the surface of the printed color image.

Although not illustrated, the printing apparatus 100 according to an embodiment may further include a processor. The processor may be accommodated into the internal space of the housing 110, and may control general operations of the first printing unit 300, the second printing unit 400, and/or the driving unit 500.

The processor may be electrically connected to the first printing unit 300 and generally control operations performed by the first printing unit 300 to print the color image having CYMK colors onto the print area of the print medium P. The processor may be electrically connected to the second printing unit 400 and generally control operations performed by the second printing unit 400 to apply the white ink onto the print area of the print medium P. The processor may control transfer of the print medium P by controlling the operation of the driving unit 500, and accordingly, the color image or the white ink may be printed onto a desired position of the print medium P.

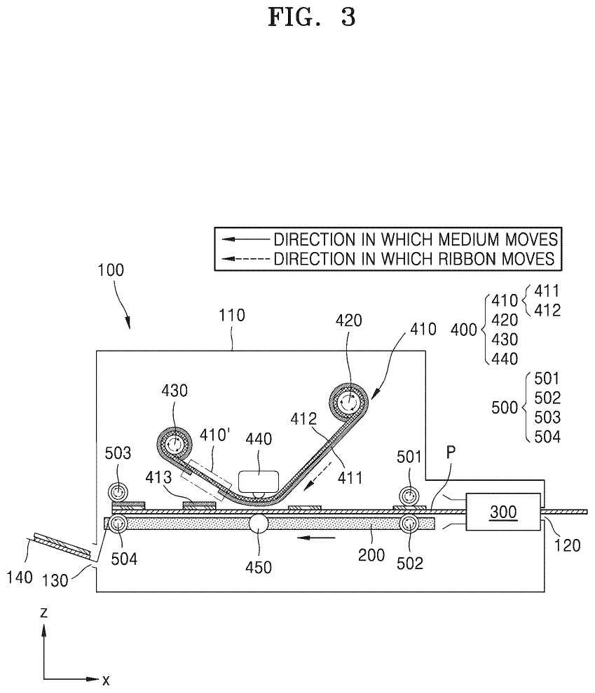

Hereinafter, the second printing unit 400 will be described in detail with reference to FIG. 3.

FIG. 3 is a cross-sectional view for describing the second printing unit 400 shown in FIG. 1 in detail. Referring to FIG. 3, the printing apparatus 100 illustrated in FIG. 3 may include the housing 110, the inlet 120, the outlet 130, the stacker 140, the flat-bed 200, the first printing unit 300, the second printing unit 400, and the driving unit 500. Components of the printing apparatus 100 shown in FIG. 3 may be identical or similar to the components of the printing apparatus 100 shown in FIGS. 1 and 2, and descriptions thereof will not be repeatedly given.

The second printing unit 400 may include an ink ribbon 410, a first roll 420, a second roll 430, and the thermal transfer head 440. The ink ribbon 410 may include the white ink. The white ink of the ink ribbon 410 may be applied onto the print area of the print medium P by using the thermal transfer method.

An end of the ink ribbon 410 may be wound around the first roll 420, and the other end of the ink ribbon 410 may be wound around the second roll 430. The ink ribbon 410 before the white ink is applied onto the print area may be wound around the first roll 420, and the ink ribbon 410 after the white ink has been applied onto the print area may be wound around the first roll 420.

To apply the white ink 410 onto the print area, the thermal transfer head 440 may push the ink ribbon 410 in a direction toward the print medium P (e.g., a −z axis direction). In this process, a portion of the ink ribbon 410 may be unwound from the first roll 420. The ink ribbon 410 unwound from the first roll 420 may be in contact with the print area of the print medium P by the thermal transfer head 440.

The ink ribbon 410 may include a first surface 411 including the white ink and a second surface 412 not including the white ink. While the white ink is being applied onto the print area, the first surface 411 may be in contact with the print area, and the second surface 412 may be in contact with the thermal transfer head 440.

The thermal transfer head 440 may be in contact with the second surface 412 of the ink ribbon 410 and may push the ink ribbon 410 in the direction toward the print medium P (e.g., the −z axis direction). Accordingly, a portion of the ink ribbon 410 may be unwound from the first roll 420, and the first surface 411 of the ink ribbon 410 that has been unwound may be in contact with the print area of the print medium P.

In a state where the first surface 411 of the ink ribbon 410 is in contact with at least an area of the print area, the thermal transfer head 440 may apply heat and/or pressure to the ink ribbon 410. When the flat-roll 450 is arranged at the lower end of the print medium P, while the thermal transfer is performed on the thermal transfer head 440, the flat-roll 450 may support the lower end of the print medium P such that appropriate heat and/or pressure may be delivered to the print medium P.

Due to the heat and/or the pressure applied from the thermal transfer head 440, the white ink 413 may be thermally transferred from the first surface 411 of the ink ribbon 410 to the print area. While thermal transfer is performed by the thermal transfer head 440, the white ink 413 may be peeled off from the first surface 411 of the ink ribbon 410, and the white ink 413 peeled off from the first surface 311 may be applied onto the print area. Simultaneously or thereafter, an ink ribbon 410′ from which the white ink has been peeled off may be rewound around the second roll 430. The printing apparatus 100 according to the disclosure may form the white blocking layer having a uniform and sufficient thickness in the print area of the print medium P, by applying the white ink onto the print area of the print medium P by using the thermal transfer method, and accordingly, the clarity of the color image printed onto the new print medium may be improved.

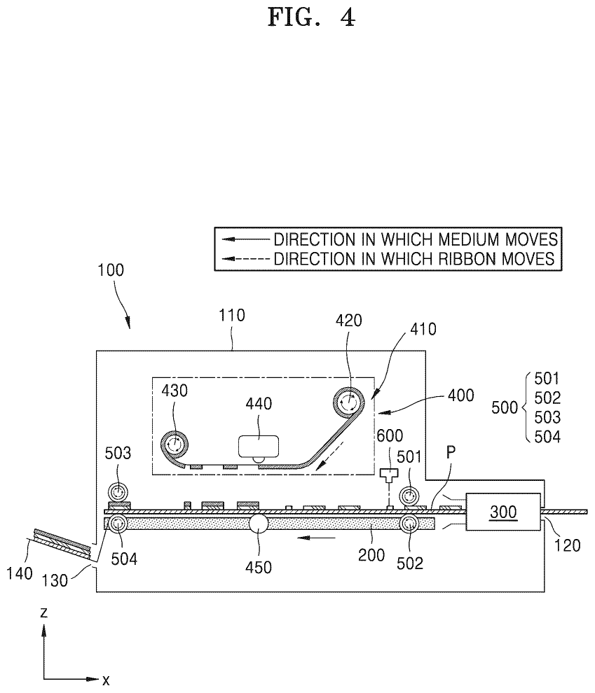

FIG. 4 is a cross-sectional view of a printing apparatus according to another embodiment. Referring to FIG. 4, the printing apparatus 100 may include the housing 110, the inlet 120, the outlet 130, the stacker 140, the first printing unit 300, the second printing unit 400, the driving unit 500, and a sensor 600. The printing apparatus 100 shown in FIG. 4 may be a printing apparatus 100 further including the sensor 600 in addition to the printing apparatus 100 shown in FIGS. 2 and 3, and descriptions thereof will not be repeatedly given.

The sensor 600 may be on the movement path of the print medium P. The sensor 600 may be upstream the printing apparatus 100. For example, the sensor 600 may be at an area right before the print medium P arrives at the second printing unit 400.

The sensor 600 may be configured to generate a trigger signal to correspond to a marker printed onto the print medium P. The marker for indicating initiation of an operation of the second printing unit 400 may be further printed onto the print medium P. The sensor 600 may be configured to detect the marker printed onto the print medium P and generate the trigger signal in response to the detected marker. When the processor receives the trigger signal issued from the sensor 600, the processor may initiate the operation of the second printing unit 400.

For example, the marker printed onto the print medium P may include a Quick Response (QR) code or a register mark. That is, a two-dimensional barcode for delivering information regarding the initiation of the operation of the second printing unit 400 or a line that is a reference for the initiation of the operation of the second printing unit 400 may be printed onto an area of the print medium P. In this case, the sensor 600 may include a trigger sensor configured to detect the QR code or the register mark. When the QR code or the register mark is detected, the sensor 600 may generate a trigger signal as a response thereto.

However, the embodiment is not limited thereto, and as another example, the marker printed onto the print medium may include an encoder marking. In this case, the sensor 600 may include a rotary encoder configured to detect the encoder marking. When the encoder marking is detected, the sensor 600 may generate a trigger signal in response thereto.

The printing apparatus 100 according to another embodiment may include the first printing unit 300, the second printing unit 400, and the sensor 600 configured to control initiation of the operation of the second printing unit 400, and therefore, may print a color image onto a print area of the print medium P and form the white blocking layer, by using one printing apparatus 100 and through one process. Accordingly, the production efficiency of the printing apparatus 100 may be improved.

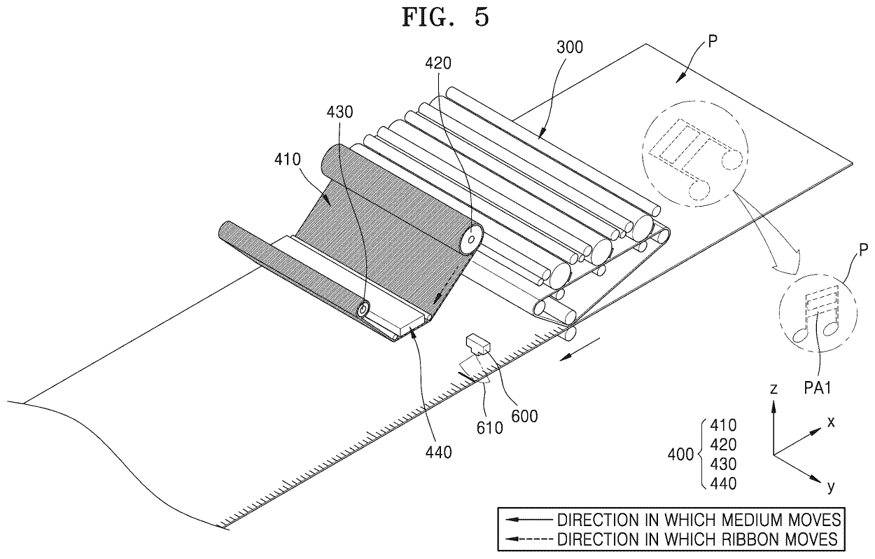

Hereinafter, changes in the print area according to time will be described with reference to FIGS. 5 to 8.

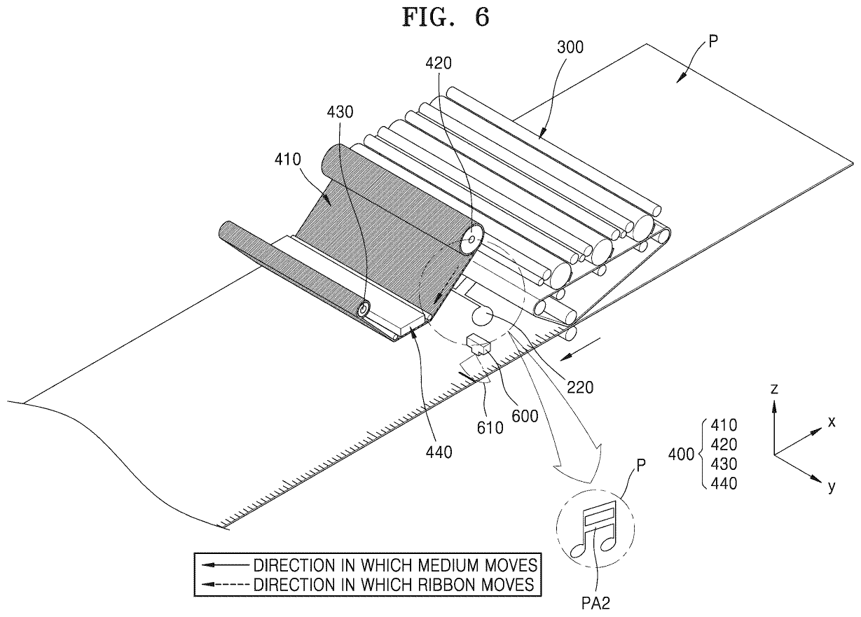

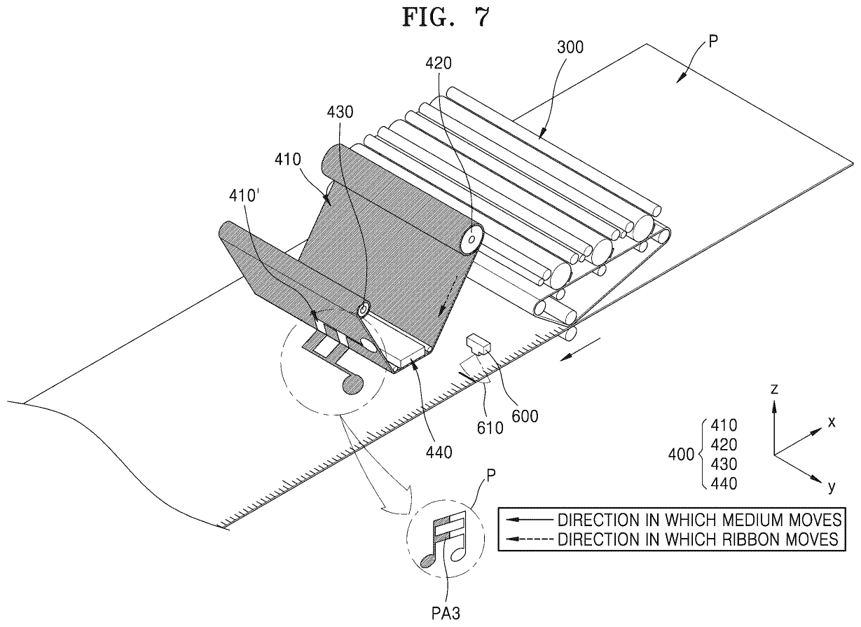

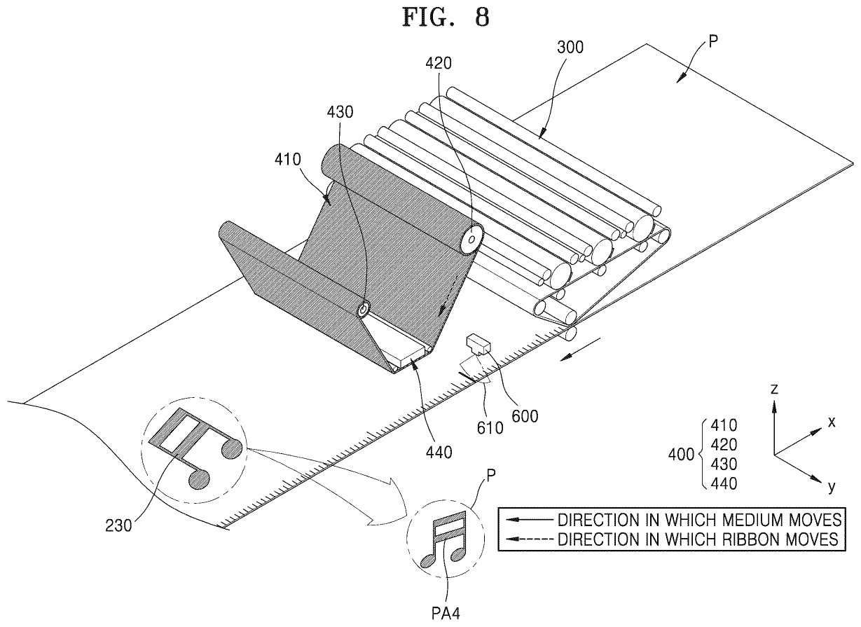

FIG. 5 is a diagram for describing a state before the color image is printed onto the print area, FIG. 6 is a diagram for describing a state in which the color image has been printed onto the print area shown in FIG. 5, FIG. 7 is a diagram for describing a state in which the white ink is being applied onto the print area shown in FIG. 6, and FIG. 8 is a diagram illustrating a state in which the white ink has been applied onto the print medium shown in FIG. 7. For convenience of explanation, FIGS. 5 to 7 only illustrate some of the components of the printing apparatus 100, but the components of the printing apparatus 100 are not limited to the components illustrated in the drawings. Accordingly, the descriptions given above regarding the printing apparatus 100 with reference to FIGS. 1 to 4 may also be applied to the components of the printing apparatus 100 shown in FIGS. 5 to 7.

Referring to FIG. 5, a print area PA1 may be arranged in the print medium P, and the print area PA1 is marked with broken lines. The color image having CYMK colors and/or the white ink may not have been printed onto the print area PA1. The print area PA1 may indicate a print area right before the print medium P arrives at the first printing unit 300 after being inserted into the printing apparatus 100.

As the print medium P moves in the direction (e.g., the −x axis direction) by the driving unit 500, the print area PA1 may arrive at the first printing unit 300. The first printing unit 300 may print the color image having CYMK colors onto the print area PA1.

Referring to FIG. 6, a print area PA2 may be arranged in the print medium P, and the print area PA2 is marked with broken lines. The color image having CYMK colors may have been printed onto the print area PA2. The print area PA2 may include a print area output from the first printing unit 300.

A marker 610 to indicate the initiation of the operation of the second printing unit 400 may be marked in an area of the print medium P. For example, the marker 610 may have been printed onto the print medium P before the print medium P is inserted into the printing apparatus 100, but is not limited thereto. As another example, the marker 610 may also be printed onto an area of the print medium P by the first printing unit 300.

The print medium P may be moved on in the direction (e.g., the −x axis direction) by the driving unit 500, and the second print area PA2 of the print medium P may arrive at the second printing unit 400. In this process, the sensor 600 may detect the marker 610 printed onto the print medium P, and may generate the trigger signal in response to the marker 610 that has been detected. The processor may initiate the operation of the second printing unit 400 based on the trigger signal generated from the sensor 600.

Referring to FIG. 7, a print area PA3 may be arranged in the print medium P, and the print area PA3 is marked with broken lines. The print area PA3 of the print medium P may be in a state in which the color image having CYMK colors has been printed and the white ink is being applied onto the color image. A portion of the print area PA3 of the print medium P may be in a state in which the white ink has been applied from the ink ribbon 410 by the thermal transfer head 440, and the other portion of the print area PA3 of the print medium P may be in a state in which only the color image having CYMK colors has been printed.

Referring to FIG. 8, a print area PA4 may be arranged in the print medium P, and the print area PA4 is marked with broken lines. The print area PA4 of the print medium P may be in a state in which the white ink has been applied by the second printing unit 400. The print area PA4 may be in a state in which the color image having CYMK colors has been printed by the first printing unit 300 and then the white blocking layer has been formed by the second printing unit 400.

In this case, the print area PA4 shown in FIG. 8 may include the entire area of the print area PA3 shown in FIG. 7. An area of the print medium P, which is occupied by the print area PA4 shown in FIG. 8, may be equal to or greater than an area of the print medium P occupied by the print area PA3 shown in FIG. 7. As the white ink is applied onto the print area PA4 shown in FIG. 8, a white-color image may be printed together with the color images printed onto the printing area PA3, and in this case, the white blocking layer may be formed on a surface of the color image.

The print medium P may be moved on to the outlet 130 of the printing apparatus 100 by the driving unit 500, and the print area PA4 of the print medium P may be output from the printing apparatus 100 through the outlet 130.

Hereinafter, the method of controlling the printing apparatus 100 described with reference to FIGS. 4 to 8 will be described.

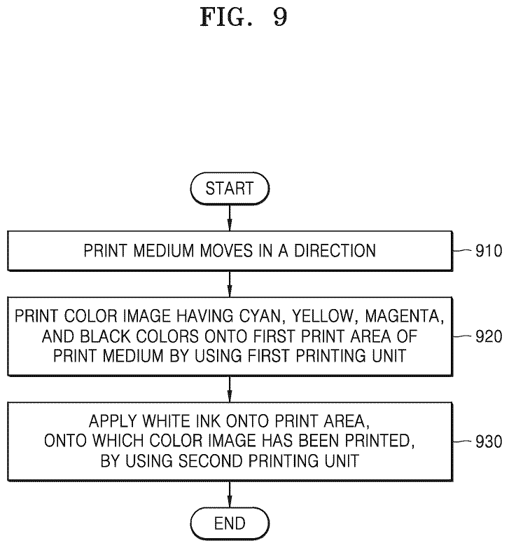

FIG. 9 is a flowchart for describing a method of controlling the printing apparatus 100, according to an embodiment. Referring to FIG. 9, the method of controlling the printing apparatus 100 includes processes performed by the printing apparatus 100 described with reference to FIGS. 4 to 8. Accordingly, the description given above regarding the printing apparatus 100, with reference to FIGS. 4 to 8, may also be applied to the method of controlling the printing apparatus 100 shown in FIG. 9.

The housing 110 may form the entire appearance of the printing apparatus 100, and the inlet 120 for inserting or inputting the print medium P into the internal space of the housing 110 may be formed in an area of the housing 110.

A print area may be arranged in at least one area of the print medium P. Here, the print medium P may include paper or a transfer film. However, the type of the print medium P is not limited thereto, and the print medium P may also include fabrics or clothes.

The method of controlling the printing apparatus 100, according to an embodiment, may be initiated as the print medium P is inserted into the internal space of the housing 110.

In 910, the print medium P inserted into the internal space of the housing 110 may be moved in a direction with reference to the housing 110. The print medium P may be inserted into the internal space of the housing 110 through the inlet 120. The inlet 120 may be arranged in an area of the housing 110. The outlet 130 may be arranged in another area of the housing 110 that is apart from the area of the housing 110. The area of the housing 110 and the other area of the housing 110 may be arranged to face each other with reference to the housing 110. The print medium P may be inserted into the internal space of the housing 110 through the inlet 120 and may be moved in the direction toward the outlet 130 in the internal space of the housing 110.

One or more driving units configured to move the print medium P in a direction (e.g., the −x axis direction) with reference to the housing 110 may be further arranged in the internal space of the housing 110. For example, the driving units may include a rail, a rack-and-pinion actuator, a driving roller, a gear, and a belt, and thus may transfer the print medium P in a direction.

The driving unit 500 may be arranged at the upper end and/or a lower end of the print medium P located upstream and/or downstream the print medium P to move the print medium P in a certain direction.

For example, the first driving unit 501 and the second driving unit 502 may be at the upper end and the lower end upstream the printing apparatus 100, respectively, and the third driving unit 503 and the fourth driving unit 504 may be at the upper end and the lower end of the print medium P downstream the printing apparatus 100, respectively.

The driving unit 500 may further include a flat-bed 200 for supporting and guiding the print medium P. Holes penetrating the flat-bed 200 may be formed in an area of the flat-bed 200, and the second driving unit 502, the fourth driving unit 504, and the flat-roll 450, which are arranged at the lower end of the print medium P, may be accommodated in the holes that have been formed.

In 920, by the first printing unit 300, a color image having CYMK colors may be printed through a digital method onto the first print area of the print medium P.

The first printing unit 300 may be on the movement path of the print medium P, and may print the color image having CYMK colors onto the first print area of the print medium P. The print medium P accommodated in the internal space of the housing 110 may be moved to the first printing unit 300 by the driving unit 500. The first printing unit 300 may print the color image having CYMK colors onto the first print area of the print medium P that has arrived at the first printing unit 300.

The first printing unit 300 may print the color image having CYMK colors, through a digital method, onto the first print area of the print medium P. For example, the first printing unit 300 may include a printing unit configured to print color images having CYMK colors by using laser beams or light-emitting diodes (LED).

The print medium P output or discharged from the first printing unit 300 may be moved in a direction toward the second printing unit 400 by the driving unit 500.

In 930, the white ink may be applied onto the second print area, onto which the color image has been printed, by the second printing unit 400.

The second printing unit 400 may be on the movement path of the print medium P, and may further apply the white ink onto the second print area of the print medium P onto which the color image has been printed. The second print area may be arranged at a same position as the first print area on the print medium P, and thus may include at least a portion of the first print area.

The second print area may include the entire area of the first print area. An area of the print medium P, which is occupied by the second print area, may be equal to or greater than an area of the print medium P occupied by the first print area.

As the white ink is applied onto the second print area, the white ink may be applied onto the entire surface of the first print area onto which the image has been printed. Due to the white ink applied onto the second print area, an image having white color may be expressed together with the image printed onto the first print area. In addition, due to the white ink applied onto the second print area, the white blocking layer may be formed on a surface of the image printed onto the first print area.

The print media P output from the first printing unit 300 may be moved to the second printing unit 400 by the driving unit 500. The second printing unit 400 may further apply the white ink onto the second print area of the print medium P that has arrived at the second printing unit 400.

The second printing unit 400 may include the ink ribbon 410, the first roll 420, the second roll 430, and the thermal transfer head 440. The ink ribbon 410 may include the white ink. The white ink of the ink ribbon 410 may be applied onto the second print area of the print medium P through the thermal transfer method.

An end of the ink ribbon 410 may be wound around the first roll 420, and the other end of the ink ribbon 410 may be wound around the second roll 430. The ink ribbon 410, which is in a state before the white ink is applied onto the second print area, may be wound around the first roll 420, and the ink ribbon 410, which is in a state in which the white ink has been applied onto the second print area, may be wound around the second roll 430.

The marker for indicating the initiation of the operation of the second printing unit 400 may be further printed onto the print medium P. The sensor 600, which is capable of generating a trigger signal in response to the marker printed onto the print medium P, may be further arranged upstream the printing apparatus 100. For example, the sensor 600 may be at an area located right before the print medium P arrives at the second printing unit 400.

The sensor 600 may be configured to detect the marker printed onto the print medium P and generate the trigger signal in response to the detected marker. When the processor receives the trigger signal issued from the sensor 600, the processor may initiate the operation of the second printing unit 400.

For example, the marker printed onto the print medium P may include a QR code or a register mark. That is, a two-dimensional barcode for delivering information regarding the initiation of the operation of the second printing unit 400 or a line that is a reference for the initiation of the operation of the second printing unit 400 may be printed onto an area of the print medium P. In this case, the sensor 600 may include a trigger sensor configured to detect the QR code or the register mark. When the QR code or the register mark is detected, the sensor 600 may generate a trigger signal as a response thereof.

However, the embodiment is not limited thereto, and as another example, the marker printed onto the print medium may include an encoder marking. In this case, the sensor 600 may include a rotary encoder configured to detect the encoder marking. When the encoder marking is detected, the sensor 600 may generate a trigger signal in response thereto.

When the operation of the second printing unit 400 is initiated in response to the trigger signal of the sensor 600, a portion of the ink ribbon 410 may be unwound from the second roll 420. The thermal transfer head 440 may push the ink ribbon 410 in the direction (e.g., the −z axis direction) toward the print medium P, and in this process, a portion of the ink ribbon 410 may be unwound from the first roll 420.

The ink ribbon 410 may include the first surface 411 including the white ink and the second surface 412 not including the white ink. The thermal transfer head 440 may be in contact with the second surface 412 of the ink ribbon 410 and may push the ink ribbon 410 in the direction toward the print medium P (e.g., the −z axis direction). Accordingly, a portion of the ink ribbon 410 may be unwound from the first roll 420, and the first surface 411 of the ink ribbon 410 that is unwound may be in contact with the second print area of the print medium P.

In a state in which the first surface 411 of the ink ribbon 410 is in contact with at least an area of the second print area, the thermal transfer head 440 may apply heat and/or pressure on the ink ribbon 410. Due to the heat and/or pressure applied from the thermal transfer head 440, the white ink 413 may be thermally transferred from the first surface 411 of the ink ribbon 410 to the second print area.

While thermal transfer is performed by the thermal transfer head 440, the white ink 413 may be peeled off from the first surface 411 of the ink ribbon 410, and the white ink 413 peeled off from the first surface 411 may be applied onto the second print area. Simultaneously or thereafter, an ink ribbon 410′ from which the white ink has been peeled off may be rewound around the second roll 430.

In the method of controlling the printing apparatus 100, according to the disclosure, by applying the white ink onto the second print area by using the thermal transfer method, the white blocking layer having a uniform and sufficient thickness may be formed in the second print area of the print medium P, and by doing so, the clarity of the color image printed on a new print medium may be improved.

Furthermore, in the method of controlling the printing apparatus 100 according to the disclosure, as the printing apparatus 100 includes the first printing unit 300, the second printing unit 400, and the sensor 600 configured to control the initiation of the operation of the second printing unit 400, the color image may be printed onto the print area of the print medium P and the white blocking layer may be formed, by using one printing apparatus 100 and through one process, and accordingly, the production efficiency of the printing apparatus 100 may be improved.

The method according to the embodiments may also be implemented in the form of a recording medium including computer-executable instructions, e.g., a program module executed by a computer. A computer-readable medium may include any available media that may be accessed by a computer and includes all of volatile media, nonvolatile media, removable media, and non-removable media. In addition, the computer-readable medium may include a computer storage medium and a communication medium. The computer storage medium includes both volatile and nonvolatile, and removable and non-removable media implemented in any method or technology for storage of information such as computer readable instructions, data structures, program modules or other data. The communication medium may include computer-readable instructions, data structures, and other data in non-transitory data signals, such as program modules.

It will be understood to one of ordinary skill in the art related to the embodiments that the embodiments may be implemented in a modified form without departing from the scope of the disclosure. Therefore, the embodiments of the disclosure should be considered as illustrative examples only, and should not be construed as limiting the scope of the disclosure. The scope of the disclosure is described in the claims rather than the foregoing description, and any modifications, substitutions and improvements of the embodiments of the disclosure should be construed as being included in the disclosure.

In the printing apparatus and the method of controlling the printing apparatus, according to various embodiments, the white blocking layer having a uniform and sufficient thickness may be formed in the print area of the print medium P, by applying the white ink into the print area of the print medium P by using the thermal transfer method, and accordingly, the clarity of the color image printed on the new print medium may be improved. In the printing apparatus and the method of controlling the printing apparatus, according to various embodiments, as the printing apparatus 100 includes the first printing unit 300, the second printing unit 400, and the sensor 600 configured to control the initiation of the operation of the second printing unit 400, the color image may be printed onto the print area of the print medium P and the white blocking layer may be formed, by using one printing apparatus 100 and through one process, and accordingly, the production efficiency of the printing apparatus 100 may be improved. In addition, as the white blocking layer is formed on the surface of the color image, an area of the print area, onto which the color image has not been printed, may also be blocked from the outside. Advantageous effects obtained by the embodiments are not limited to the aforementioned embodiments, and other unmentioned effects may be clearly understood to one of ordinary skill in the art based on the present specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A printing apparatus comprising:
a housing;
a first printing unit configured to move in a direction with reference to the housing and print a color image having cyan, yellow, magenta, and black (CYMK) colors, through a digital method, onto a first print area of a print medium;
a second printing unit located on a movement path of the print medium and configured to apply white ink onto a second print area; and
a processor configured to control an operation of at least one of the first printing unit and the second printing unit,
wherein the second printing area comprises at least an area of the first printing area.

2. The printing apparatus of claim 1, wherein:
after the color image has been printed onto the first printing area by the first printing unit, the white ink is applied onto the second print area by the second printing unit.

3. The printing apparatus of claim 1, wherein the second printing unit is apart from the first printing unit in a direction in which the print medium moves.

4. The printing apparatus of claim 1, wherein the second printing unit comprises:
an ink ribbon comprising the white ink;
a first roll around which an end of the ink ribbon is wound;
a second roll around which the other end of the ink ribbon is wound; and
a thermal transfer head configured to thermally transfer the white ink from the ink ribbon onto the second print area,
wherein after the white ink has been thermally transferred from the ink ribbon, which is unwound from the first roll, to the second print area, the ink ribbon, from which the white ink has been peeled off, is wound around the second roll.

5. The printing apparatus of claim 4, wherein the ink ribbon further comprises:
a first surface comprising the white ink and being in contact with at least an area of the print medium by the thermal transfer head during thermal transfer; and
a second surface that does not comprise the white ink and is in contact with the thermal transfer head during thermal transfer.

6. The printing apparatus of claim 1, further comprising:
a sensor located on a movement path of the print medium and configured to generate a trigger signal in response to a marker printed onto the print medium, and
the processor is configured to initiate an operation of the second printing unit based on the generated trigger signal.

7. The printing apparatus of claim 6, wherein the marker comprises at least one of a Quick Response (QR) code, a register mark, and an encoder marking.

8. A method of controlling a printing apparatus, the method comprising:
moving of a print medium in a direction, with reference to a housing;
printing a color image having cyan, yellow, magenta, and black (CYMK) colors, through a digital method, on a first print area of the print medium by a first printing unit located on a movement path of the print medium; and
applying of white ink onto a second printing area by a second printing unit located on the movement path of the print medium,
wherein the second printing area comprises at least an area of the first printing area.

9. The printing apparatus of claim 8, wherein:
the second printing unit comprises an ink ribbon comprising the white ink, a first roll around which an end of the ink ribbon is wound, a second roll around which the other end of the ink ribbon is wound, and a thermal transfer head configured to thermally transfer the white ink from the ink ribbon onto the second print area, and
the printing of the white ink onto the second print area by the second printing unit comprises
initiating an operation of the second printing unit;
controlling the ink ribbon to be unwound from the first roll and then wound around the second roll; and
thermally transferring the white ink, by the thermal transfer head, from the ink ribbon onto the second print area.

10. The method of claim 9, wherein initiating the operation of the second printing unit comprises:
generating a trigger signal, by a sensor, in response to the marker printed onto the print medium; and
initiating the operation of the second printing unit based on the trigger signal that has been generated.
